(19) United States
(12) Patent Application Publication
(10) Pub. No.: US 2011/0022692 A1
(43) Pub. Date: Jan. 27, 2011

(54) METHOD AND SYSTEM FOR DETERMINING AND CONTROLLING USER EXPERIENCE IN A NETWORK

(76) Inventors: Jeyhan Karaoguz, Irvine, CA (US); Bruce Currivan, Dove Canyon, CA (US); Wael William Diab, San Francisco, CA (US); Yongbum Kim, San Jose, CA (US); Kenneth Ma, Cupertino, CA (US); Michael Johas Teener, Santa Cruz, CA (US)

Correspondence Address: MCANDREWS HELD & MALLOY, LTD, 500 WEST MADISON STREET, SUITE 3400, CHICAGO, IL, 60661, US

(21) Appl. No.: 12/756,900

(22) Filed: Apr. 8, 2010

Related U.S. Application Data
(60) Provisional application No. 61/228,337, filed on Jul. 24, 2009.

(51) Int. Cl. G06F 15/177

(52) U.S. Cl. 709/221

(57) ABSTRACT

Aspects of a method and system for determining and controlling user experience in a network may comprise a management entity that coordinates operation of one or more endpoint devices. One or more parameters associated with a content type may be received from the one or more endpoint devices by the management entity. The management entity may utilize the received one or more parameters associated with the content type to determine configuration information for the one or more endpoint devices. The content type may specify a type of media content that is handled by the one or more endpoint devices.

### CROSS-REFERENCE TO RELATED APPLICATIONS/INCORPORATION BY REFERENCE

This application makes reference to, claims priority to, and claims benefit of U.S. Provisional Application Ser. No. 61/228,337, filed Jul. 24, 2009.

### FIELD OF THE INVENTION

Certain embodiments of the invention relate to communications. More specifically, certain embodiments of the invention relate to a method and system for determining and controlling user experience in a network.

### BACKGROUND OF THE INVENTION

In an ideal situation, a transmitter may transmit information over a channel or medium and the transmitted information may be received without alteration and processed by a receiver. However, a transmission medium or channel may be constantly subjected to impairments such as noise and interference. Consequently, when a transmitter transmits information, a receiver may not receive the information in an identical manner in which it was transmitted. This may be due to impairments in a channel that may typically introduce errors in the transmitted information. A transmitter may code the data in such a manner that error introduced during transmission may be detected and/or corrected during reception.

Today's Internet Protocol Television (IPTV) applications require movement of large data files and content that may include gigabytes of data across IP networks. These IP networks may include carrier access networks such as digital subscriber line (DSL) and/or cable networks, the public Internet or local wired and wireless LANs in customer premises. The IP networks may be capable to transport data packets, but by nature are best effort networks. In other words, if unexpected network conditions such as congestion is encountered, data packets may be dropped based on certain policies. The use of transport control protocol (TCP), an upper layer protocol above IP, may enable requesting retransmission of the lost packets from the origin, and therefore guaranteeing reliability at the expense of possible latency. The TCP/IP may be useful for non-time critical data, for example, unicast data between a server and a client. However, in many cases such as broadcast video, the same content may reach thousands of customers, and multicast IP network delivery may be the best available choice and in such cases, TCP/IP may be unsuitable.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for determining and controlling user experience in a network, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating determination and control of user experience in a network by a management entity, in accordance with an embodiment of the invention.

FIG. 1B is a diagram illustrating determination and control of user experience in a network comprising a service provider and a content provider, in accordance with an embodiment of the invention.

FIG. 2A is a block diagram of an exemplary endpoint device, in accordance with an embodiment of the invention.

FIG. 2B is a block diagram of an exemplary management entity, in accordance with an embodiment of the invention.

FIG. 3 is a diagram illustrating an exemplary registry in a management entity, in accordance with an embodiment of the invention.

FIG. 4 is a flow chart illustrating exemplary steps for determination and control of user experience in a network corresponding a user's service class, in accordance with an embodiment of the invention.

FIG. 5 is a flow chart illustrating exemplary steps for determination and control of user experience in a network, in accordance with an embodiment of the invention.

### DETAILED DESCRIPTION OF THE INVENTION

Certain embodiments of the invention may be found in a method and system for determining and controlling user experience in a network. In various embodiments of the invention, a communication system may comprise a management entity that coordinates operation of one or more endpoint devices. One or more parameters associated with a content type may be received from the one or more endpoint devices by the management entity. The management entity may utilize the received one or more parameters associated with the content type to determine configuration information for the one or more endpoint devices. The content type may specify a type of media content that is handled by the one or more endpoint devices.

In accordance with another embodiment of the invention, the management entity may be operable to determine the configuration information based on a comparison between the received one or more parameters corresponding to the one or more endpoint devices with a service class associated with the corresponding one of the one or more endpoint devices.

In accordance with another embodiment of the invention, one or more updated parameters associated with the content type may be received from the one or more endpoint devices, wherein the management entity may be operable to utilize the one or more updated parameters associated with the content type to determine new configuration information for the one or more endpoint devices. The determined new configuration information for the one or more endpoint devices may be communicated to the one or more endpoint devices.

The one or more parameters associated with the content type may comprise one or more of an error rate, a time period of errors, a data download time period, latency, jitter, signal to noise ratio (SNR), signal to interference noise ratio (SINR), carrier to noise ratio (CNR), carrier to interference noise ratio (CINR) and/or receive signal strength indication (RSSI) of the one or more endpoint devices. A registry for the management entity may be updated based on the received one or more parameters associated with the content type. The registry may comprise one or more of an identification number, a service class, the content type and/or a list of the one or more parameters for each of the one or more endpoint devices. The one or more parameters may be received via one or both of a wireless and/or a wired connection. The configuration information may be communicated via one or both of a wireless and/or a wired connection. The management entity may be one or both of a content provider and/or a service provider.

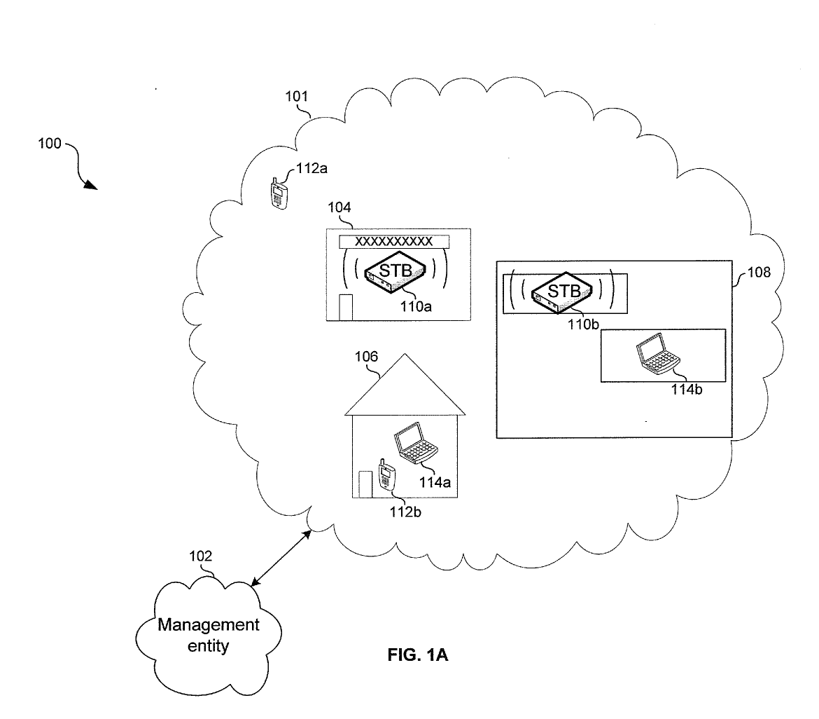

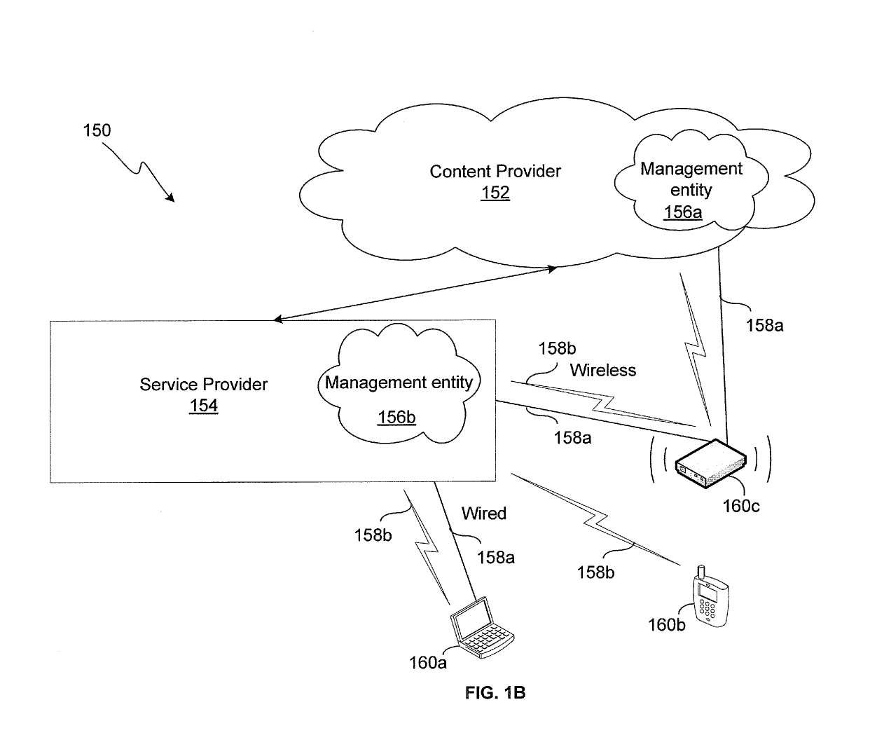

FIG. 1A is a diagram illustrating determination and control of user experience in a network by a management entity, in accordance with an embodiment of the invention. Referring to FIG. 1A, there is shown a communication system 100 comprising a sub-network 101, and a management entity 102. The exemplary sub-network 101 may comprise a plurality of endpoint devices. Exemplary endpoint devices may comprise media players, HD television systems, video and/or still cameras, game consoles, set-top boxes (STBs), cell phones, laptops, televisions sets, display devices and/or location determination enabled devices. For example, the sub-network 101 may comprise a plurality of STBs 110a and 110b, which are collectively referred to herein as STBs 110, a plurality of cell phones 112a and 112b, which are collectively referred to herein as cell phones 112, and a plurality of laptops 114a and 114b, which are collectively referred to herein as laptops 114. The STB 110a may be installed in one or more commercial properties 104, the STB 110b and laptop 114b may be installed in one or more residential properties 106, the laptop 114a and the cell phone 112b may be located in one or more multi-tenant properties 108, and/or the cell phone 112a may be located within the sub-network 101. Notwithstanding, the invention may not be so limited and the plurality of endpoint devices may be located and/or installed in any other location, for example, an office without departing from the scope of the invention.

The commercial properties 104 may comprise, for example, stores, restaurants, offices, and municipal buildings. The residential properties 106 may comprise, for example, single-family homes, home offices, and/or town-houses. Multi-tenant properties 108 may comprise residential and/or commercial tenants such as apartments, condos, hotels, and/or high rises.

The management entity 102 may comprise suitable logic, circuitry, interfaces and/or code for managing operating parameters of one more endpoint devices, for example, the STB 110b, the cell phone 112b, and/or the laptop 114b. The cell phones 112 and the laptops 114 may each comprise suitable logic, circuitry, interfaces and/or code that may be operable to communicate wirelessly utilizing one or more wireless standards such as IS-95, CDMA, EVDO, GSM, TDMA, GPRS, EDGE, UMTS/WCDMA, TD-SCDMA, HSPA (HSUPA and/or HSDPA), WIMAX and/or LTE. The cell phones 112 and the laptops 114 may be operable to communicate based on Bluetooth, Zigbee and/or other suitable wireless technologies. The management entity 102 may be operable to provide access to the Internet and/or one or more private networks via one or more of optical, wired, and/or wireless connections. In various embodiments of the invention, the optical, wired, and/or wireless connections may comprise a broadband connection such as a digital subscriber line (DSL), Ethernet, passive optical network (PON), a T1/E1 line, a cable television infrastructure, a satellite television infrastructure, and/or a satellite broadband Internet connection.

The STBs 110 may comprise suitable logic, circuitry, interfaces and/or code that may be operable to connect to a display device, for example, a television set and an external source of signal from the management entity 102. The STBs 110 may be operable to convert the received signal from the management entity 102 to content, which may be displayed on a display device, for example, a television set. The STBs 110 may be operable to provide Internet connectivity, multimedia downloads and/or IP telephony sessions.

The cell phones 112 and/or laptops 114 may each comprise suitable logic, circuitry, interfaces, and/or code that may be operable to communicate utilizing one or more cellular standards. The cell phones 112 and/or laptops 114 may be operable to receive, process, and present multimedia content and may additionally be enabled run a network browser or other applications for providing Internet services to a user of the cell phones 112 and/or laptops 114.

In operation, the management entity 102 may be operable to coordinate operation of one or more endpoint devices, for example, the STBs 110, the cell phones 112, and/or the laptops 114. One or more parameters corresponding to one or more endpoint devices, for example, the STBs 110, the cell phones 112, and/or the laptops 114 associated with a particular content type may be received by the management entity 102. The management entity 102 may be operable to utilize the one or more parameters associated with the particular content type to determine configuration information for the one or more endpoint devices, for example, the STBs 110, the cell phones 112, and/or the laptops 114.

The management entity 102 may be operable to determine the configuration information based on a comparison between the received one or more parameters corresponding to the one or more endpoint devices, for example, the STBs 110, the cell phones 112, and/or the laptops 114 with a service class associated with the corresponding one of the one or more endpoint devices. The management entity 102 may be operable to control a quality of the content viewed by a user in accordance with a designated service class based on receiving the one or more parameters corresponding to the one or more endpoint devices, for example, the STBs 110, the cell phones 112, and/or the laptops 114.

FIG. 1B is a diagram illustrating determination and control of user experience in a network comprising a service provider and a content provider, in accordance with an embodiment of the invention. Referring to FIG. 1B, there is shown a communication system 150. The communication system 150 may comprise a content provider 152, a service provider 154, wired 158a and/or wireless connections 158b, and a plurality of endpoint devices, for example, a laptop 160a, a cell phone 160b, and a set-top box (STB) 160c. The content provider 152 may comprise a management entity 156a and the service provider 154 may comprise a management entity 156b. The management entities 156a and 156b, the laptop 160a, the cell phone 160b, and the STB 160c may be substantially similar to the corresponding blocks as described with respect to FIG. 1A.

The content provider 152 may comprise suitable logic, circuitry, interfaces and/or code that may be operable to generate and/or provide a plurality of types of content, for example, audio data, video data and/or text data. The content provider 152 may be operable to communicate the received data to one or more endpoint devices, for example, the STB 160c, the laptop 160a and/or the cell phone 160b either directly or indirectly via the service provider 154, for example.

The service provider 154 may comprise suitable logic, circuitry, interfaces and/or code that may be operable to receive data from the content provider 152. The service provider 154 may be operable to communicate the received data to one or more endpoint devices, for example, the STB 160c, the laptop 160a and/or the cell phone 160b. The service provider 154 may be operable to provide access to the Internet and/or one or more private networks via one or more of optical, wired 158a, and/or wireless connections 158b. In various embodiments of the invention, the optical, wired 158a, and/or wireless connections 158b may comprise a broadband connection such as a digital subscriber line (DSL), Ethernet, passive optical network (PON), a T1/E1 line, a cable television infrastructure, a satellite television infrastructure, and/or a satellite broadband Internet connection.

In operation, the management entity 156a and/or 156b may be operable to coordinate operation of one or more endpoint devices, for example, the STB 160c, the cell phone 160b, and/or the laptop 160a. One or more parameters corresponding to one or more endpoint devices, for example, the STB 160c, the cell phone 160b, and/or the laptop 160a associated with a particular content type may be received by the management entity 156a and/or 156b. The management entity 156a and/or 156b may be operable to utilize the one or more parameters associated with the particular content type to determine configuration information for the one or more endpoint devices, for example, the STB 160c, the cell phone 160b, and/or the laptop 160a.

The management entity 156a and/or 156b may be operable to determine the configuration information based on comparing the received one or more parameters corresponding to the one or more endpoint devices, for example, the STB 160c, the cell phone 160b, and/or the laptop 160a with a service class associated with the corresponding one of the one or more endpoint devices. The management entity 156a and/or 156b may be operable to control a quality of the content viewed by a user in accordance with a designated service class based on receiving the one or more parameters corresponding to the one or more endpoint devices, for example, the STB 160c, the cell phone 160b, and/or the laptop 160a.

The management entity 156a and/or 156b may be operable to receive one or more updated parameters associated with the content type from the one or more endpoint devices, for example, the STB 160c, the cell phone 160b, and/or the laptop 160a. The management entity 156a and/or 156b may be operable to utilize the one or more updated parameters associated with the content type to determine new configuration information for the one or more endpoint devices, for example, the STB 160c, the cell phone 160b, and/or the laptop 160a. The management entity 156a and/or 156b may be operable to communicate the determined new configuration information to the one or more endpoint devices, for example, the STB 160c, the cell phone 160b, and/or the laptop 160a. The one or more parameters associated with the particular content type may comprise one or more of an error rate, a time period of errors, a data download time period, latency, jitter, signal to noise ratio (SNR), signal to interference noise ratio (SINR), carrier to noise ratio (CNR), carrier to interference noise ratio (CINR) and/or receive signal strength indication (RSSI) of the one or more endpoint devices, for example, the STB 160c, the cell phone 160b, and/or the laptop 160a.

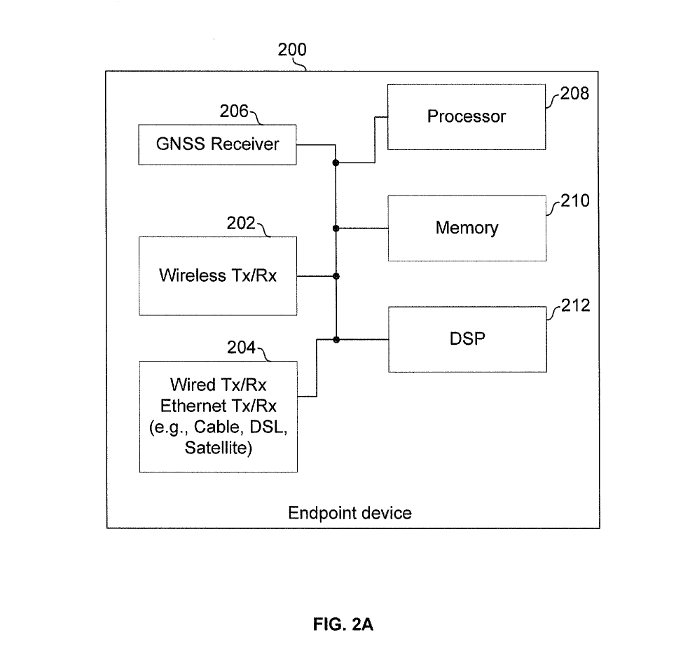

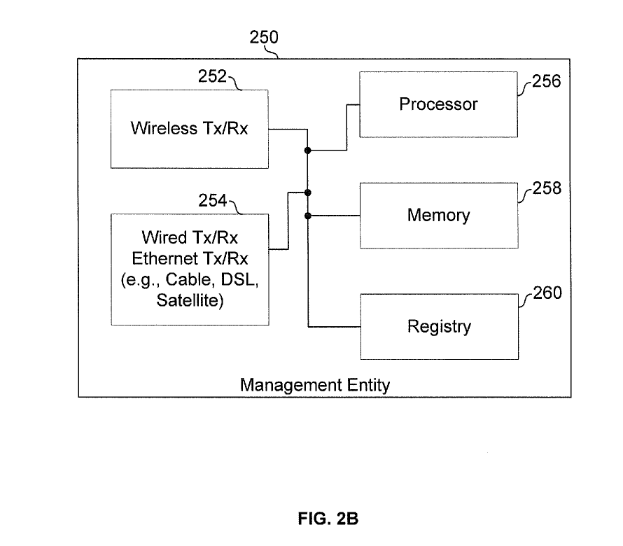

FIG. 2A is a block diagram of an exemplary endpoint device, in accordance with an embodiment of the invention. Referring to FIG. 2A, there is shown an endpoint device 200. The endpoint device 200 may comprise a wireless Tx/Rx 202, a wired Tx/Rx 204, a global navigation satellite system (GNSS) receiver 206, a processor 208, a memory 210, and a DSP 212.

The wireless broadband Tx/Rx 202 may comprise suitable logic, circuitry, interfaces and/or code that may be operable to transmit and/or receive data, in adherence with one or more broadband communication standards, to and/or from the service provider 154 and/or the content provider 152 via the wireless connection 158b. The wireless broadband Tx/Rx 202 may be operable to perform amplification, down-conversion, filtering, demodulation, and analog to digital conversion of received signals. In addition, the wireless broadband Tx/Rx 202 may be operable to perform amplification, up-conversion, filtering, modulation, and digital to analog conversion of transmitted signals.

The wired Tx/Rx 204 may comprise suitable logic, circuitry, interfaces and/or code that may be operable to transmit and/or receive data to and/or from the service provider 154 and/or the content provider 152 via the wired connection 158a. For example, the wired Tx/Rx 204 may transmit and/or receive data via a T1/E1 line, PON, DSL, cable television infrastructure, satellite broadband internet connection and/or satellite television infrastructure for example. In various embodiments of the invention, the wired Tx/Rx 204 may be operable to perform exemplary operations and/or functions comprising amplification, down-conversion, filtering, demodulation, and analog to digital conversion of received signals. In addition, the wired Tx/Rx 204 may be operable to perform exemplary operations and/or functions comprising amplification, up-conversion, filtering, modulation, and digital to analog conversion of transmitted signals.

The GNSS receiver 206 may comprise suitable logic, circuitry, interfaces and/or code that may be operable to receive signals from one or more GNSS satellites, for example, GLONASS, GALILEO and/or GPS satellites. The received signals may comprise timing, ephemeris, long term orbit information, and/or almanac information that enable the GNSS receiver 206 to determine its location and/or time.

The processor 208 may comprise suitable logic, circuitry, interfaces and/or code that may be operable to process data and/or control operations of the endpoint device 200. In this regard, the processor 208 may be operable to provide control signals to the various other blocks within the endpoint device 200. The processor 208 may also control data transfers between various portions of the endpoint device 200. Additionally, the processor 208 may enable execution of applications programs and/or code. In various embodiments of the invention, the applications, programs, and/or code may enable, for example, parsing, transcoding and/or otherwise processing of data. The data may comprise multimedia data comprising voice, video, text, still images, and/or moving images. The processor 208 may be operable to communicate one or more parameters to the management entity 156a and/or 156b. The processor 208 may be operable to receive the configuration information from the service provider 154 and/or the content provider 154.

In various embodiments of the invention, the applications, programs, and/or code may be operable to, for example, configure and/or control operation of the wireless Tx/Rx 202 and/or wired Tx/Rx 204 and/or the GNSS receiver 206, the memory 210, and/or the DSP 212.

The memory 210 may comprise suitable logic, circuitry, interfaces and/or code that may enable storage or programming of information that comprises, for example, parameters and/or code that may effectuate the operation of the endpoint device 200. Exemplary parameters may comprise configuration data and exemplary code may comprise operational code such as software and/or firmware, but the information need not be limited in this regard. Additionally, the memory 210 may buffer or otherwise store received data and/or data to be transmitted. The memory 210 may be operable to store the configuration information from the service provider 154 and/or the content provider 154.

The DSP 212 may comprise suitable logic, circuitry, interfaces and/or code that may be operable to perform computationally intensive processing of data. The DSP 212 may be operable to handle exemplary operations comprising encoding, decoding, modulating, demodulating, encryption, decryption, scrambling, descrambling, and/or otherwise processing of data.

In operation, the processor 208 may be operable to communicate one or more parameters corresponding to the endpoint device 200 associated with a particular content type to the management entity 102. The management entity 102 may be operable to utilize the one or more parameters associated with the particular content type to determine configuration information for the endpoint device 200.

The processor 208 may be operable to configure the endpoint device 200 based on receiving from the management entity 102, the determined configuration information for the endpoint device 200. The processor 208 may be operable to communicate one or more updated parameters associated with the content type to the management entity 102. The processor 208 may be operable to configure and/or reconfigure the endpoint device 200 based on receiving existing, default, and/or new configuration information from the management entity 102.

FIG. 2B is a diagram illustrating an exemplary management entity, in accordance with an embodiment of the invention. Referring to FIG. 2B, there is shown a management entity 250. The management entity 250 may comprise a wireless Tx/Rx 252, a wired Tx/Rx 254, a processor 256, a memory 258, and a registry 260. The wireless Tx/Rx 252 and the wired Tx/Rx 254 may be substantially similar to the corresponding blocks as described with respect to FIG. 2A.

The processor 256 may comprise suitable logic, circuitry, interfaces and/or code that may be operable to receive one or more parameters from the endpoint device 200. The processor 256 may be operable to dynamically update a registry 260 based on the received one or more parameters from the endpoint device 200. The processor 256 may be operable to process data and/or control operations of the management entity 250. In this regard, the processor 256 may be operable to provide control signals to the various other blocks within the management entity 250. The processor 256 may also control data transfers between various portions of the management entity 250. Additionally, the processor 256 may enable execution of applications programs and/or code. In various embodiments of the invention, the applications, programs, and/or code may enable, for example, parsing, transcoding and/or otherwise processing data. The processor 256 may be operable to determine configuration information based on comparison of the received one or more parameters corresponding to the endpoint device 200 with a service class associated with the endpoint device 200. The processor 256 may be operable to communicate the configuration information to the endpoint device 200.

In various embodiments of the invention, the applications, programs, and/or code may be operable to, for example, configure and/or control operation of the wireless Tx/Rx 252 and/or wired Tx/Rx 254, the memory 258, and/or the registry 260.

The memory 260 may comprise suitable logic, circuitry, interfaces and/or code that may be operable to store or program information that includes, for example, parameters and/or code that may effectuate the operation of the management entity 250. Exemplary parameters may comprise configuration data and exemplary code may comprise operational code such as software and/or firmware, but the information need not be limited in this regard. Additionally, the memory 260 may buffer or otherwise store received data and/or data to be transmitted.

The registry 260 may comprise suitable logic, circuitry, interfaces and/or code that may be operable to store one or more of an error rate, a time period of errors, a data download time period, latency, jitter, signal to noise ratio (SNR), signal to interference noise ratio (SINR), carrier to noise ratio (CNR), carrier to interference noise ratio (CINR) and/or receive signal strength indication (RSSI) of each of the endpoint devices 200.

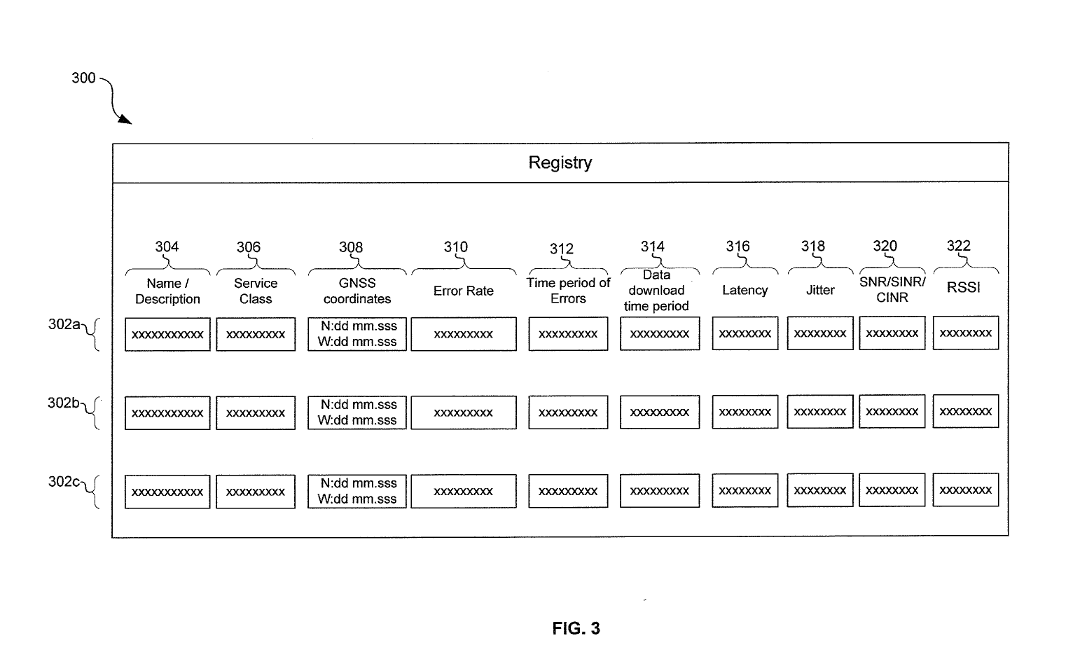

FIG. 3 is a diagram illustrating an exemplary registry in a management entity, in accordance with an embodiment of the invention. Referring to FIG. 3, the registry 300 comprises a plurality of endpoint device entries 302a, 302b, and 302c, collectively referred to herein as entries 302. Although only three entries 302 are depicted, the invention may not be so limited and any number of entries may be displayed and/or viewable in the registry 300. Each entry 302 may comprise a name/description field 304, a service class 206, a GNSS coordinates field 308, an error rate field 310, a time period of errors field 312, a data download time period field 314, a latency field 316, a jitter field 318, a noise ratio field 320, and a receive signal strength indication (RSSI) field 322. The noise ratio field 320 may comprise one or more of a signal to interference noise ratio (SINR), a carrier to noise ratio (CNR), and/or a carrier to interference noise ratio (CINR).

The name/description field 304 may provide information to uniquely describe an endpoint device 200. The service class field 306 may comprise information regarding the designated service class for each endpoint device 200. The GNSS coordinates field 308 may indicate the current GNSS coordinates of an endpoint device 200. The error rate field 310 may indicate a number of errors in the received data per unit time from the management entity 250, for example. The time period of errors field 312 may indicate a number of seconds of errored data received from the management entity 250, for example. The data download time period field 314 may indicate a time period to download a unit of data from the management entity 250, for example. The latency field 316 may indicate a latency of the data received from the management entity 250, for example. The jitter field 318 may indicate the amount of jitter in the data received from the management entity 250, for example. The noise ratio field 320 may indicate the SINR, CNR, and/or a CINR of the data received from the management entity 250, for example. The RSSI field 322 may indicate the RSSI of the data received from the management entity 250, for example.

In operation, the plurality of parameters in the registry 300 may be dynamically updated based on receiving one or more of the parameters from the endpoint devices 200. The parameters may be communicated to the registry 300 and the processor 256 may be operable to determine the configuration information based on the received parameters. The management entity 250 may be operable to determine the configuration information based on comparing the received one or more parameters with a service class 306 associated with the corresponding endpoint device 200.

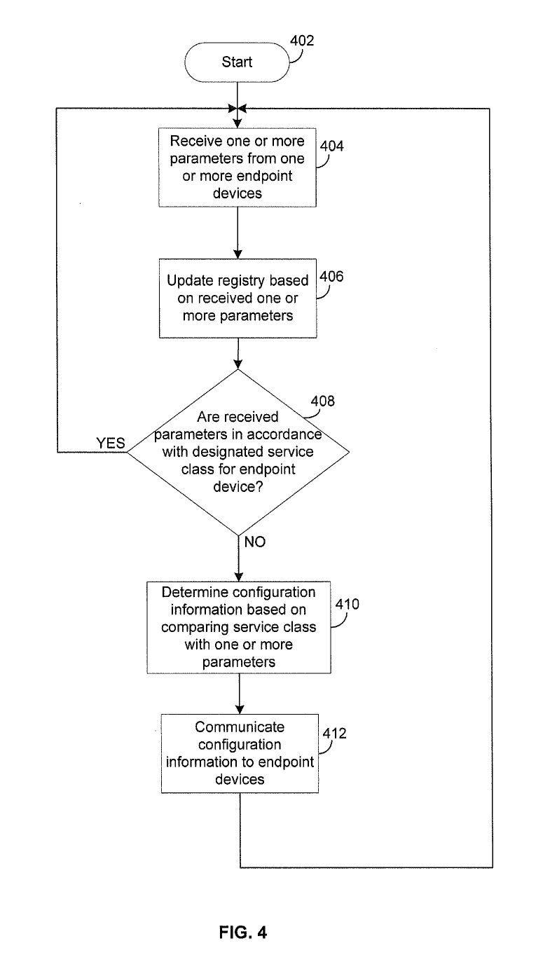

FIG. 4 is a flow chart illustrating exemplary steps for determination and control of user experience in a network corresponding a user's service class, in accordance with an embodiment of the invention. Referring to FIG. 4, exemplary steps may begin at step 402. In step 404, a management entity 250 may receive one or more parameters from the endpoint device 200. In step 406, a registry 300 may be dynamically updated based on the received one or more parameters. In step 408, it may be determined whether the received parameters corresponding to the endpoint device 200 are in accordance with the designated service class 306 of the endpoint device 200. In instances where the received parameters corresponding to the endpoint device 200 are in accordance with the designated service class 306 of the endpoint device 200, control returns to step 404. In instances where the received parameters corresponding to the endpoint device 200 are not in accordance with the designated service class 306 of the endpoint device 200, control passes to step 410.

In step 410, the management entity 250 may be operable to determine the configuration information based on comparing the received one or more parameters corresponding to the endpoint device 200 with the service class 306 associated with the endpoint device 200. In step 412, the management entity 250 may be operable to communicate the configuration information to the endpoint device 200. Control then returns to step 404.

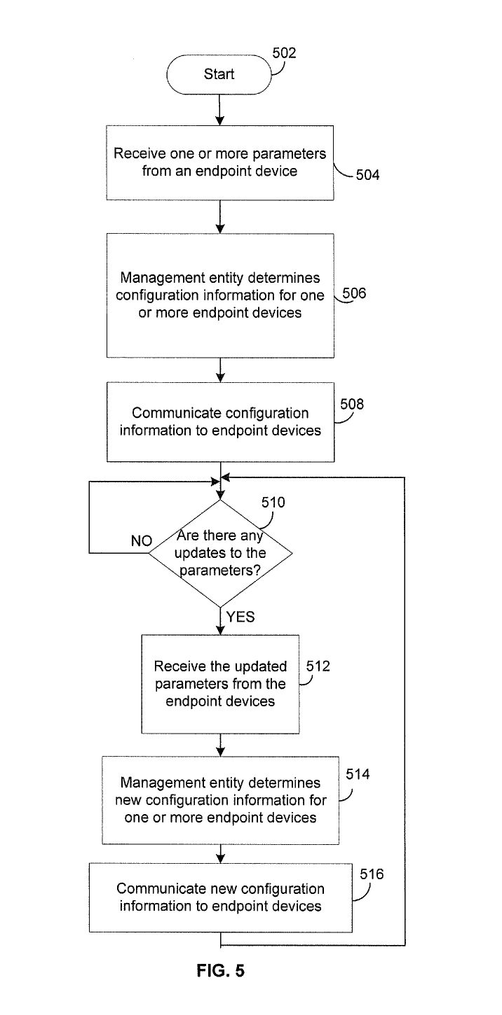

FIG. 5 is a flow chart illustrating exemplary steps for determination and control of user experience in a network, in accordance with an embodiment of the invention. Referring to FIG. 5, exemplary steps may begin at step 502. In step 504, one or more parameters may be received from the endpoint device 200. In step 506, the management entity 250 may be operable to utilize the one or more parameters to determine configuration information for the endpoint device 200. In step 508, the management entity 250 may be operable to communicate the determined configuration information to the endpoint device 200.

In step 510, it may be determined whether there are any updates to one or more parameters received from the endpoint device 200. In instances where there are no updates to the one or more received parameters, control returns to step 510. In instances where there are updates to the one or more received parameters, control passes to step 512. In step 512, the management entity 250 may be operable to receive the one or more updated parameters from the endpoint device 200. In step 514, the management entity 250 may be operable to determine new configuration information for the endpoint device 200 based on receiving the updated parameters. In step 516, the management entity 250 may be operable to communicate the determined new configuration information to the endpoint device 200. Control then returns to step 510.

In accordance with an embodiment of the invention, a method and system for determining and controlling user experience in a network may comprise a communication system 100 (FIG. 1A). The communication system 100 may comprise a management entity 102 (FIG. 1A) that may be operable to coordinate operation of one or more endpoint devices, for example, the STB 110a (FIG. 1A), the cell phone 112a (FIG. 1A), and/or the laptop 114a (FIG. 1A). One or more processors, for example, processor 256 (FIG. 2B) and/or circuits for use in the management entity 250 (FIG. 2B) may be operable to receive one or more parameters associated with a content type from the one or more endpoint devices, for example, the STB 110a, the cell phone 112a, and/or the laptop 114a. The content type may specify a type of media content that is handled by the one or more endpoint devices. The management entity 102 may be operable to utilize the one or more parameters associated with the content type to determine configuration information for the one or more endpoint devices, for example, the STB 110a, the cell phone 112a, and/or the laptop 114a. One or more processors, for example, processor 256 and/or circuits for use in the management entity 250 may be operable to communicate the determined configuration information to the one or more endpoint devices, for example, the STB 110a, the cell phone 112a, and/or the laptop 114a.

One or more processors, for example, processor 256 and/or circuits for use in the management entity 250 may be operable to determine the configuration information based on comparison of the received one or more parameters corresponding to the one or more endpoint devices, for example, the STB 110a, the cell phone 112a, and/or the laptop 114a with a service class associated with the corresponding one of the one or more endpoint devices, for example, the STB 110a, the cell phone 112a, and/or the laptop 114a. The management entity 250 may be operable to control a quality of the content viewed by a user in accordance with a designated service class based on receiving the one or more parameters corresponding to the one or more endpoint devices, for example, the STB 110a, the cell phone 112a, and/or the laptop 114a to the management entity 102 and determining the configuration information for each of the one or more endpoint devices.

One or more processors, for example, processor 256 and/or circuits for use in the management entity 250 may be operable to receive one or more updated parameters associated with the content type from the one or more endpoint devices, for example, the STB 110a, the cell phone 112a, and/or the laptop 114a. One or more processors, for example, processor 256 and/or circuits for use in the management entity 250 may be operable to utilize the one or more updated parameters associated with the content type to determine new configuration information for the one or more endpoint devices, for example, the STB 110a, the cell phone 112a, and/or the laptop 114a. One or more processors, for example, processor 256 and/or circuits for use in the management entity 250 may be operable to communicate the determined new configuration information to the one or more endpoint devices, for example, the STB 110a, the cell phone 112a, and/or the laptop 114a.

The one or more parameters associated with the content type may comprise one or more of an error rate, a time period of errors, a data download time period, latency, jitter, signal to noise ratio (SNR), signal to interference noise ratio (SINR), carrier to noise ratio (CNR), carrier to interference noise ratio (CINR) and/or receive signal strength indication (RSSI) of the one or more endpoint devices, for example, the STB 110a, the cell phone 112a, and/or the laptop 114a.

The registry 300 (FIG. 3) for the management entity may be updated based on the received one or more parameters associated with the content type. The registry 300 may comprise one or more of an identification number, a service class, the content type and/or a list of the one or more parameters for each of the one or more endpoint devices. One or more processors, for example, processor 256 and/or circuits for use in the management entity 250 may be operable to receive the one or more parameters and communicate the configuration information via one or both of a wireless 158b and/or a wired connection 158a. The management entity 106 may be one or both of a content provider 152 and/or a service provider 154.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for determining and controlling user experience in a network.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for network management, the method comprising:
in a communication system comprising a management entity that coordinates operation of one or more endpoint devices:
receiving at said management entity, one or more parameters associated with a content type from said one or more endpoint devices; and
determining configuration information for said one or more endpoint devices based on said received one or more parameters associated with said content type, and said content type specifies a type of media content that is handled by said one or more endpoint devices.

2. The method according to claim 1, comprising determining said configuration information based on comparison of said received one or more parameters corresponding to said one or more endpoint devices with a service class associated with said corresponding one of said one or more endpoint devices.

3. The method according to claim 1, comprising receiving one or more updated parameters associated with said content type from said one or more endpoint devices

4. The method according to claim 3, comprising determining new configuration information for said one or more endpoint devices based on said received one or more updated parameters associated with said content type.

5. The method according to claim 4, comprising communicating said determined new configuration information to said one or more endpoint devices.

6. The method according to claim 1, wherein said one or more parameters associated with said content type comprises one or more of: an error rate, a time period of errors, a data download time period, latency, jitter, signal to noise ratio (SNR), signal to interference noise ratio (SINR), carrier to noise ratio (CNR), carrier to interference noise ratio (CINR) and/or receive signal strength indication (RSSI) of said one or more endpoint devices.

7. The method according to claim 1, comprising updating a registry for said management entity based on said communicated one or more parameters associated with said content type.

8. The method according to claim 7, wherein said registry comprises one or more of: an identification number, a service class, said content type and/or a list of said one or more parameters for each of said one or more endpoint devices.

9. The method according to claim 1, comprising receiving said one or more parameters and communicating said configuration information via one or both of: a wireless and/or a wired connection.

10. The method according to claim 1, wherein said management entity is one or both of: a content provider and/or a service provider.

11. A system for network management, the system comprising:
in a communication system comprising a management entity that coordinates operation of one or more endpoint devices, one or more processors and/or circuits for use in said management entity, wherein said one or more processors and/or circuits are operable to:
receive at said management entity, one or more parameters associated with a content type from said one or more endpoint devices; and
determine configuration information for said one or more endpoint devices based on said received one or more parameters associated with said content type, and said content type specifies a type of media content that is handled by said one or more endpoint devices.

12. The system according to claim 11, wherein said one or more processors and/or circuits are operable to determine said configuration information based on comparison of said received one or more parameters corresponding to said one or more endpoint devices with a service class associated with said corresponding one of said one or more endpoint devices.

13. The system according to claim 11, wherein said one or more processors and/or circuits are operable to receive one or more updated parameters associated with said content type from said one or more endpoint devices

14. The system according to claim 13, wherein said one or more processors and/or circuits are operable to determine new configuration information for said one or more endpoint devices based on said received one or more updated parameters associated with said content type.

15. The system according to claim 14, wherein said one or more processors and/or circuits are operable to communicate said determined new configuration information to said one or more endpoint devices.

16. The system according to claim 11, wherein said one or more parameters associated with said content type comprises one or more of: an error rate, a time period of errors, a data download time period, latency, jitter, signal to noise ratio (SNR), signal to interference noise ratio (SINR), carrier to noise ratio (CNR), carrier to interference noise ratio (CINR) and/or receive signal strength indication (RSSI) of said one or more endpoint devices.

17. The system according to claim 11, wherein said one or more processors and/or circuits are operable to update a registry for said management entity based on said received one or more parameters associated with said content type.

18. The system according to claim 17, wherein said registry comprises one or more of: an identification number, a service class, said content type and/or a list of said one or more parameters for each of said one or more endpoint devices.

19. The system according to claim 11, wherein said one or more processors and/or circuits are operable to receive said one or more parameters and communicate said configuration information via one or both of: a wireless and/or a wired connection.

20. The system according to claim 11, wherein said management entity is one or both of: a content provider and/or a service provider.
